(19) United States
(12) Patent Application Publication
(10) Pub. No.: US 2024/0179253 A1
(43) Pub. Date: May 30, 2024

(54) RECORDING DEVICE FRAME AND RECORDING DEVICE

(71) Applicant: SEIKO EPSON CORPORATION, Tokyo (JP)

(72) Inventors: Yukiya BEPPU, MATSUMOTO-SHI (JP); Nobuaki SAKAI, SHIOJIRI-SHI (JP); Ryota TAKAYANAGI, AZUMINO-SHI (JP)

(21) Appl. No.: 18/520,173

(22) Filed: Nov. 27, 2023

(30) Foreign Application Priority Data
Nov. 28, 2022 (JP) 2022-188954

(51) Int. Cl. H04N 1/00

(52) U.S. Cl. CPC H04N 1/00538; H04N 1/00557; H04N 1/00559

(57) ABSTRACT

A base frame includes a top surface member formed from a plate-shaped material, a bottom surface member formed from a plate-shaped material and disposed in parallel to the top surface member, and a reinforcing member disposed between the top surface member and the bottom surface member. The reinforcing member is formed from a plate-shaped material, and includes a main body portion having a flat plate shape and intersecting the top surface member and the bottom surface member. The main body portion includes a first contact portion in contact with the bottom surface member and a second contact portion in contact with the top surface member.

The present application is based on and claims priority from JP Application Serial Number 2022-188954, filed Nov. 28, 2022, the disclosure of which is hereby incorporated by reference herein in its entirety.

### BACKGROUND

### 1. Technical Field

The present disclosure relates to a recording device frame that supports a recording device, and to a recording device.

### 2. Related Art

In a relatively large device among recording devices configured to record an image or the like on a medium, components constituting the device are supported by a high-strength frame. Among such frames, a base frame that serves as a base of the device is required to be formed to be flat with a high degree of accuracy, as well as to have a high strength. JP-A-2005-345856 proposes a frame formed by sandwiching a square hollow member, formed into the square shape by bending a plate-shaped material, between two plate-shaped materials, and joining the hollow member and the two plate-shaped materials by welding.

In the frame described in JP-A-2005-345856, the flatness of the frame depends on the accuracy of the bending process. However, it is difficult to realize the required accuracy only by the bending process, and a secondary process such as cutting is required in some cases.

### SUMMARY

A recording device frame includes a top surface member formed from a plate-shaped material, a bottom surface member formed from a plate-shaped material and disposed in parallel to the top surface member, and a reinforcing member disposed between the top surface member and the bottom surface member. The reinforcing member is formed from a plate-shaped material and includes a main body portion having a flat plate shape and intersecting the top surface member and the bottom surface member. The main body portion includes a first end surface in contact with the bottom surface member, and a second end surface in contact with the top surface member.

A recording device includes a frame, and a recording unit supported by the frame and configured to perform recording on a medium. The frame includes a top surface member formed from a plate-shaped material, a bottom surface member formed from a plate-shaped material and disposed in parallel to the top surface member, and a reinforcing member disposed between the top surface member and the bottom surface member. The reinforcing member is formed from a plate-shaped material and includes a main body portion having a flat plate shape and intersecting the top surface member and the bottom surface member. The main body portion includes a first end surface in contact with the bottom surface member, and a second end surface in contact with the top surface member.

### BRIEF DESCRIPTION OF THE DRAWINGS

FIG. 1 is a perspective view illustrating the front side of a recording device.

FIG. 2 is a perspective view illustrating the front side of the recording device.

FIG. 3 is a perspective view of the rear side of the recording device.

FIG. 4 is a perspective view illustrating the rear side of the recording device.

FIG. 5 is a perspective view illustrating a base frame.

FIG. 6 is a plan view of a top surface member.

FIG. 7 is a plan view of a bottom surface member.

FIG. 8 is an exploded perspective view illustrating the base frame.

FIG. 9 is a perspective view illustrating a reinforcing member.

FIG. 10 is a perspective view illustrating the reinforcing member.

FIG. 11 is a cross-sectional view illustrating the reinforcing member.

FIG. 12 is a cross-sectional view illustrating the reinforcing member.

FIG. 13 is a plan view illustrating a state in which the reinforcing member is disposed on the top surface member.

### DESCRIPTION OF EMBODIMENTS

An embodiment of a recording device 1 will be described below with reference to the accompanying drawings. The recording device 1 according to the present embodiment is, for example, an inkjet-type printer configured to discharge ink, which is an example of a liquid, onto a medium, which is an object on which recording is performed, and to record an image such as characters or a photo on the medium. The material of the medium is not limited to paper, and various materials such as textiles including cloth and woven fabric, vinyl chloride resin, and the like can be used.

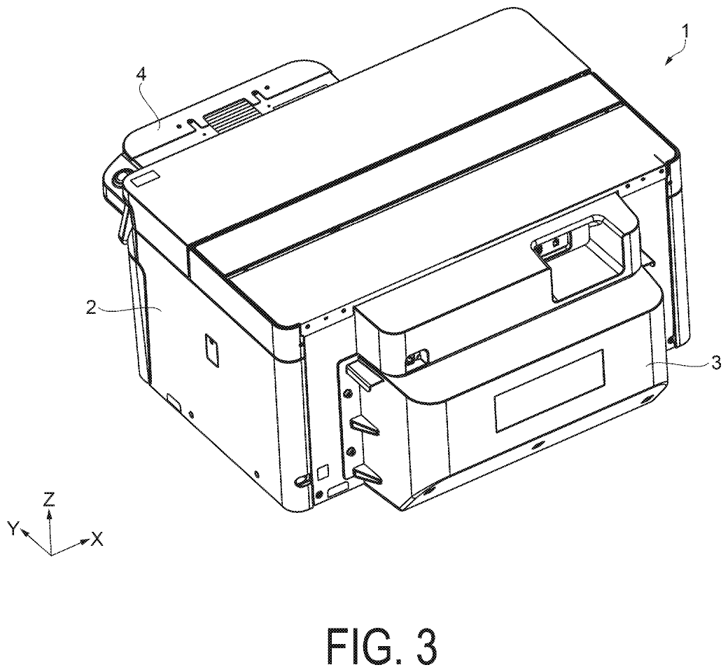

In each of the drawings except for FIG. 3, an X-axis, a Y-axis, and a Z-axis intersecting each other are illustrated. Typically, the X-axis, the Y-axis, and the Z-axis are orthogonal to each other. The X-axis is parallel to an installation surface of the recording device 1, and corresponds to a width direction of the recording device 1. The Y-axis is parallel to the installation surface of the recording device 1, and corresponds to a depth direction of the recording device 1. The Z-axis is perpendicular to the installation surface of the recording device 1, and corresponds to a height direction of the recording device 1.

Hereinafter, a +Y direction parallel to the Y-axis is a direction from the front side to the rear side of the recording device 1, and a −Y direction parallel to the Y-axis is a direction opposite to the +Y direction. A +X direction parallel to the X-axis is a direction from the front side to the left side of the recording device 1, and a −X direction parallel to the X-axis is a direction opposite to the +X direction. A +Z direction parallel to the Z-axis is an upward direction, and a −Z direction parallel to the Z-axis is a direction opposite to the +Z direction.

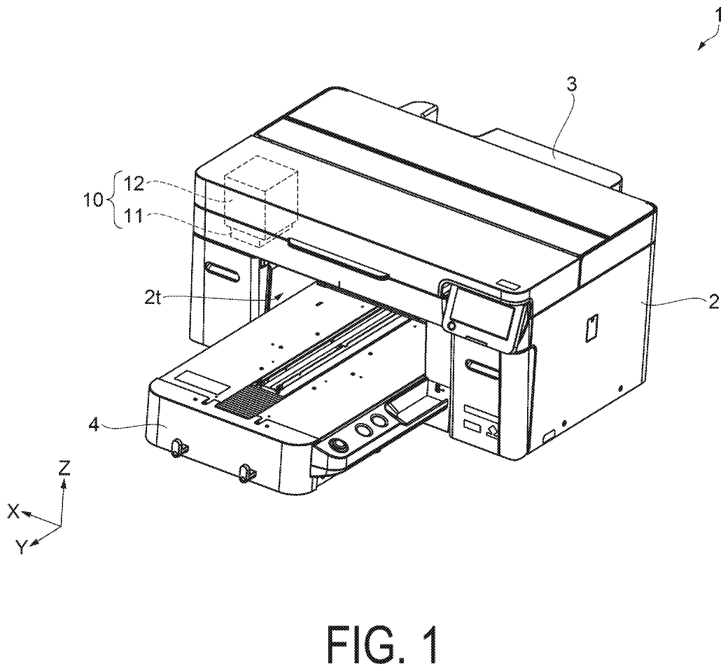

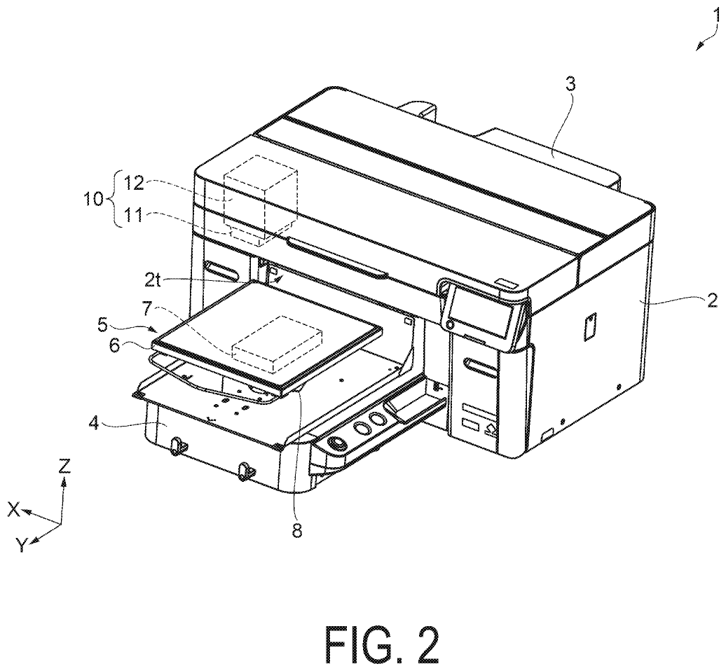

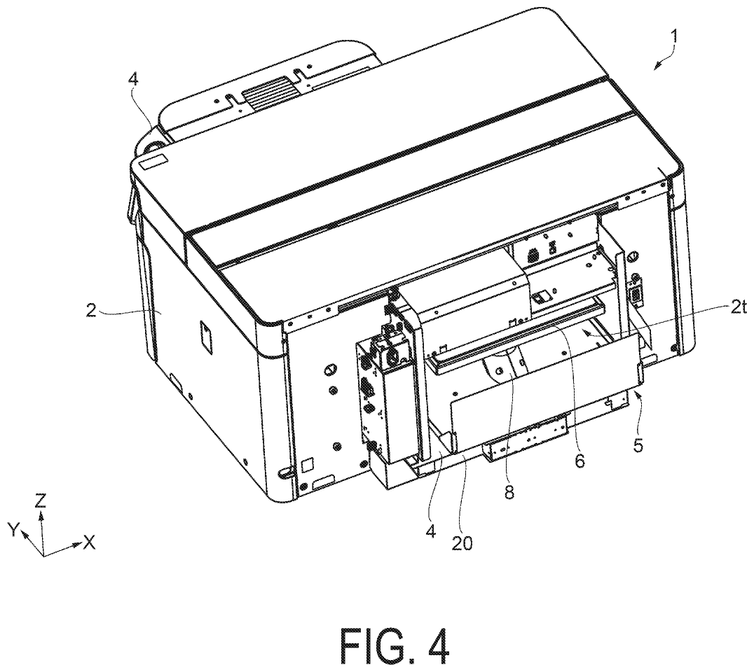

FIGS. 1 and 2 are perspective views illustrating the front side of the recording device 1 according to the present embodiment. FIG. 1 is a diagram illustrating a state in which a medium support unit 5 described below is positioned inside a housing 2, and FIG. 2 is a diagram illustrating a state in which the medium support unit 5 is positioned outside the housing 2. FIGS. 3 and 4 are perspective views illustrating the rear side of the recording device 1. FIG. 3 is a diagram illustrating a state in which a rear cover 3 described below is mounted on the recording device 1, and FIG. 4 is a diagram illustrating a state in which the rear cover 3 is removed from the recording device 1.

As illustrated in FIGS. 1 to 4, the recording device 1 includes the housing 2 that accommodates a device main body. A through hole 2t penetrating from the front side to the rear side of the housing 2 is provided at the housing 2, and a medium moving unit 4 whose longitudinal direction is the +Y directions is disposed so as to protrude from the through hole 2t in the +Y direction and the −Y direction. The medium moving unit 4 supports the medium support unit 5 that supports the medium, so that the medium support unit 5 is movable in the +Y directions. The medium moving unit 4 is driven by a drive mechanism (not illustrated) to move the medium support unit 5 in the +Y directions. On the rear side of the housing 2, the through hole 2t is covered by the rear cover 3 having a box shape.

The medium support unit 5 includes a tray 6 that supports the medium, a stage 7 as a support table that supports the tray 6, and a base 8 that supports the stage 7. The stage 7 and the tray 6 are movable in the vertical direction with respect to the base 8, that is, in the +Z directions by an elevating mechanism (not illustrated). In other words, the position of the medium in the height direction can be adjusted by the elevating mechanism. Note that the +Z directions, which are the moving directions of the stage 7, may be directions slightly inclined from the vertical direction. Further, in the recording device 1, the stage 7 is configured to support the medium via the tray 6, but the stage 7 may be configured to directly support the medium.

A recording unit 10 constituting the device main body is disposed inside the housing 2. The recording unit 10 includes a recording head 11 that performs recording on the medium by discharging ink, a carriage 12 that holds the recording head 11, and a drive mechanism (not illustrated) that moves the carriage 12 in the +X directions. The recording device 1 causes the recording head 11 to discharge the ink toward the medium supported by the tray 6, while causing the carriage 12 to reciprocate in the +X directions. Since the housing 2 is configured to cover an entire movement range of the carriage 12, the housing 2 has a long shape in the +X directions.

When the medium support unit 5 is positioned further to the +Y direction than the through hole 2t of the housing 2, that is, when the medium support unit 5 is positioned outside the housing 2 (see FIG. 2), the medium is set on the tray 6. After the medium is set on the tray 6, the medium support unit 5 is transported by the medium moving unit 4 to the inside of the housing 2, that is, the inside of the through hole 2t (see FIG. 1), and moved to a recording start position located at an end portion of the medium moving unit 4 in the −Y direction. Then, the recording device 1 alternately repeats an operation of discharging the ink from the recording head 11 while moving the carriage 12 in the +X directions, and an operation of moving the medium support unit 5 by a predetermined amount in the +Y direction, in order to record an image on a wide area of the medium.

As illustrated in FIG. 4, a base frame 20 that supports the entire recording device 1 is disposed at the bottom of the recording device 1. The base frame 20 corresponds to a recording device frame and to a frame.

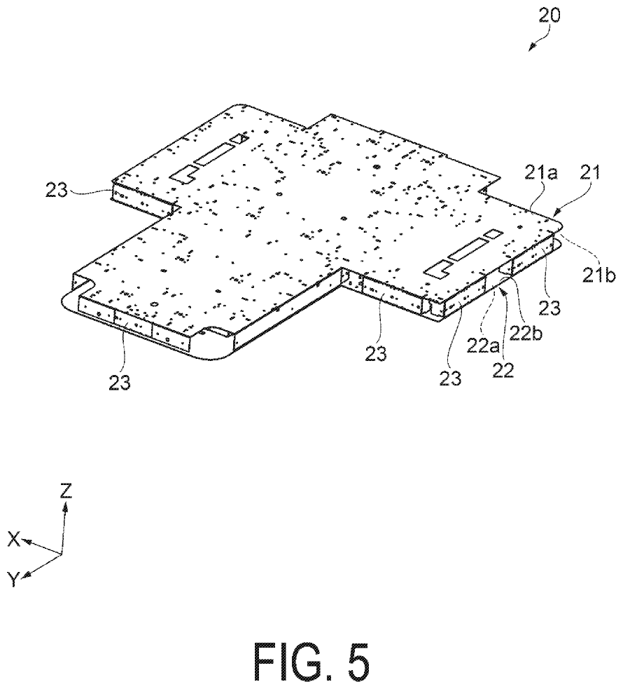

FIG. 5 is a perspective view illustrating the base frame 20.

As illustrated in FIG. 5, since the base frame 20 supports the device main body accommodated in the housing 2 that is long in the +X directions, and the medium moving unit 4 that is long in the +Y directions, the base frame 20 has a substantially cross shape. The base frame 20 is required to have a strength capable of withstanding the weight of the recording device 1, and is required to be flat with a high degree of accuracy because the base frame 20 serves as a reference for the moving operations of the medium support unit 5 and the carriage 12.

The base frame 20 includes a top surface member 21 constituting a top surface thereof, a bottom surface member 22 disposed in parallel to the top surface member 21 and constituting a bottom surface thereof, and a plurality of reinforcing members 23 disposed between the top surface member 21 and the bottom surface member 22. Each of these members is formed from a plate-shaped material made of steel, that is, a steel plate. As the steel plate, for example, a galvanized steel plate or the like is used. The top surface member 21, the bottom surface member 22, and the reinforcing members 23 are cut into predetermined shapes by cutting dies, and thereafter, are formed by being subjected to necessary respective bending processes. Here, the cutting includes a processing method in which a cutting die is set in a press machine to perform die cutting.

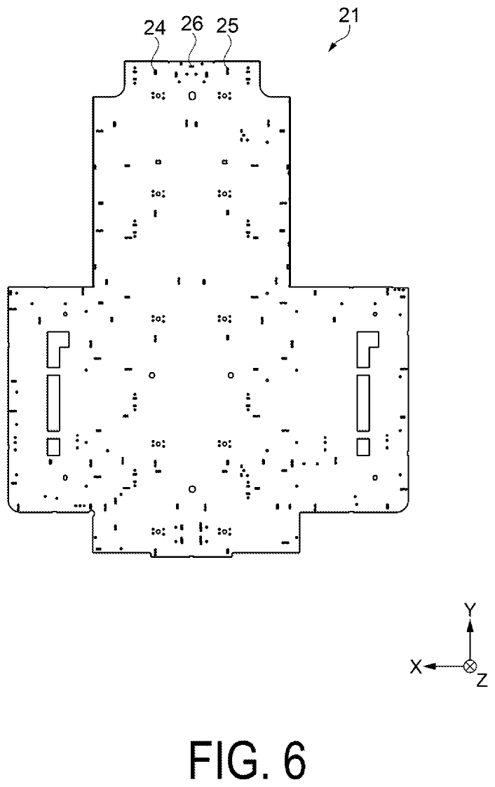

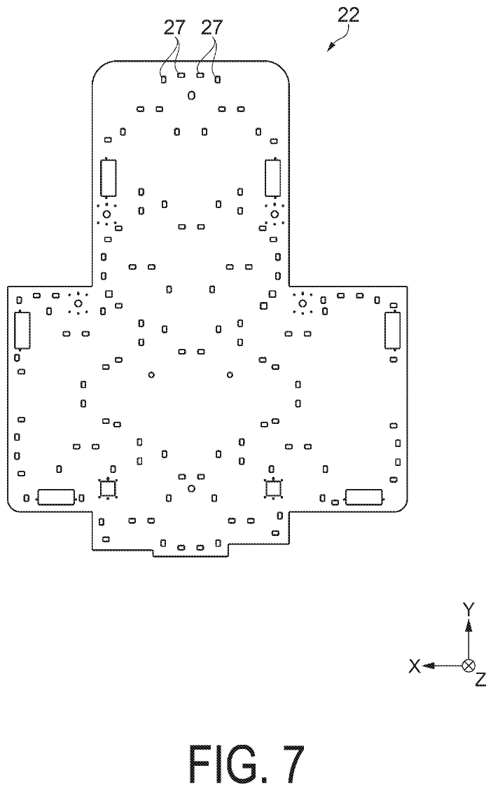

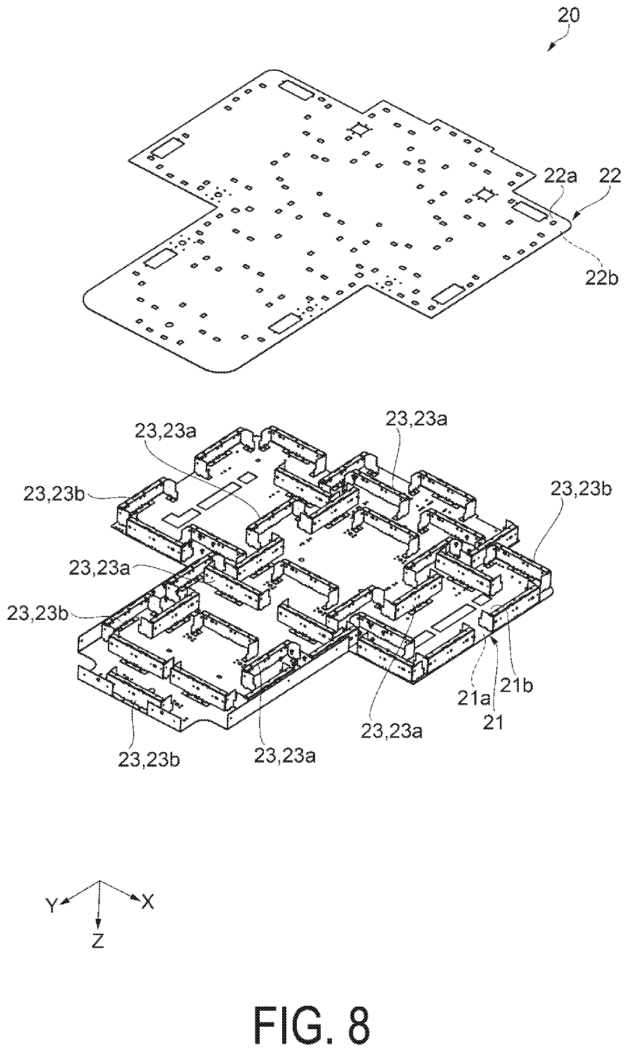

FIG. 6 is a plan view of the top surface member 21, and FIG. 7 is a plan view of the bottom surface member 22. FIG. 8 is an exploded perspective view illustrating the base frame 20. FIG. 8 illustrates a state in which the base frame 20 is turned upside down and the bottom surface member 22 is separated from the base frame 20.

As illustrated in FIGS. 6 and 7, the top surface member 21 and the bottom surface member 22 are the plate-shaped materials each formed in a substantially cross shape. Further, as illustrated in FIG. 8, each of the reinforcing members 23 is disposed at a predetermined position with a predetermined orientation, between the top surface member 21 and the bottom surface member 22.

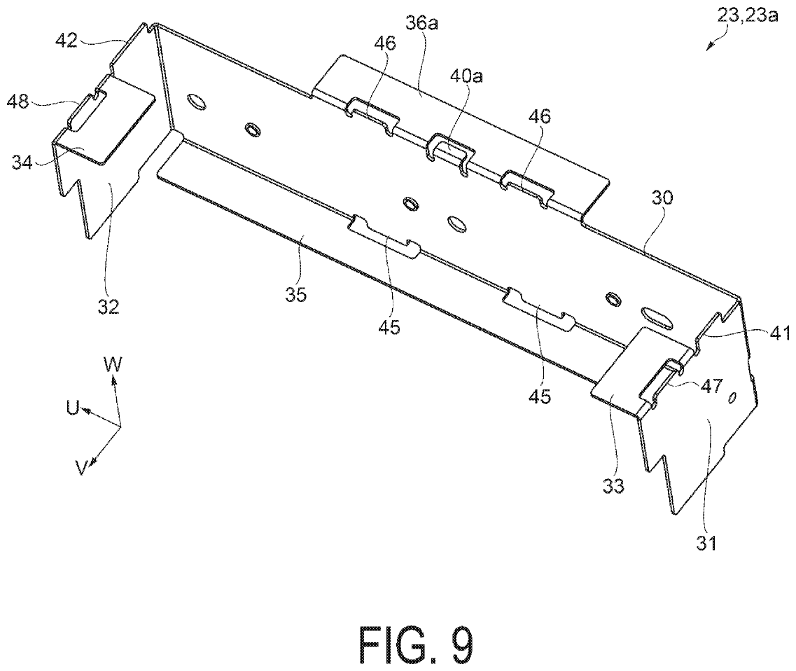

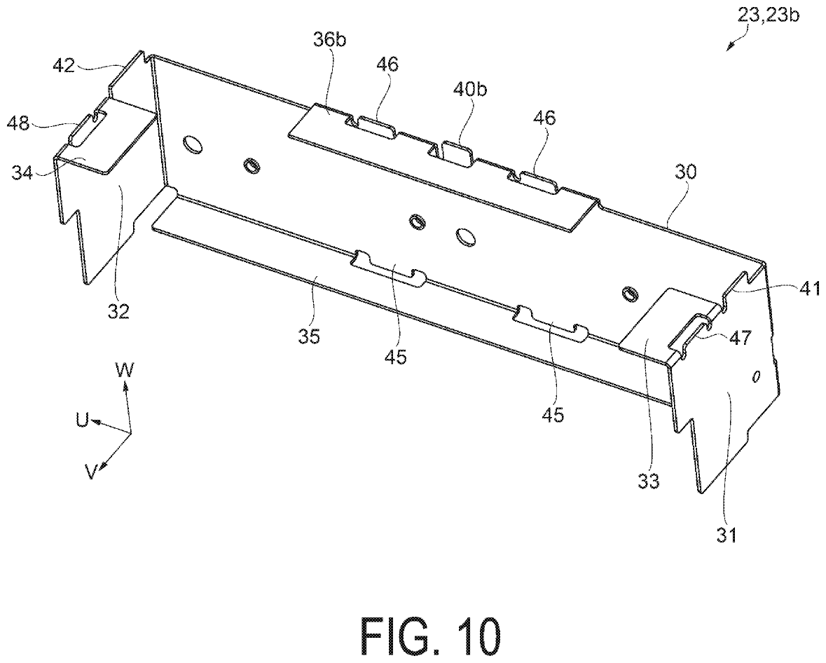

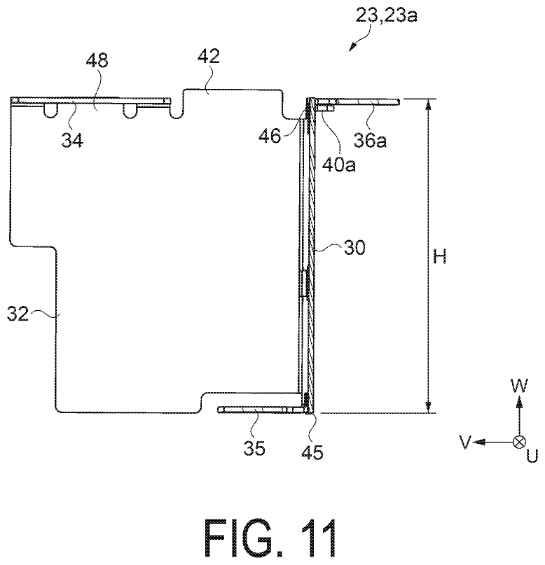

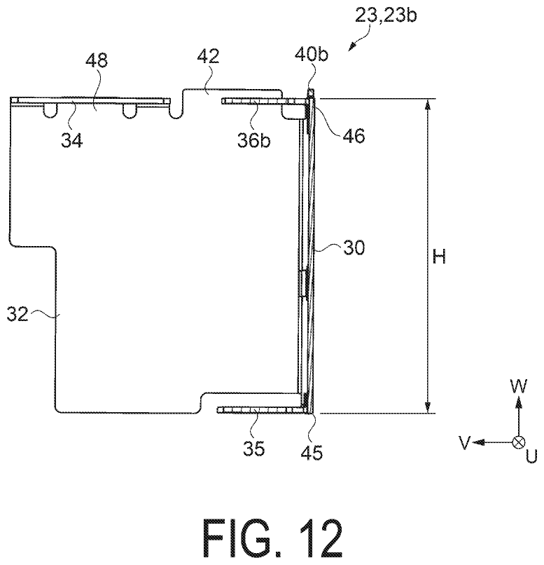

FIGS. 9 and 10 are perspective views illustrating the reinforcing member 23, and FIGS. 11 and 12 are cross-sectional views illustrating the reinforcing member 23. In FIGS. 9 to 12, a U axis, a V axis and a W axis intersecting each other are illustrated. Typically, the U-axis, the V-axis, and the W-axis are orthogonal to each other. The reinforcing member 23 is disposed such that the +W direction coincides with the +Z direction.

In the present embodiment, each of the plurality of reinforcing members 23 corresponds to one of a first reinforcing member 23a and a second reinforcing member 23b. The first reinforcing member 23a and the second reinforcing member 23b are each formed from a plate-shaped material cut into the same shape using a common cutting die, but have different shapes by being subjected to different bending processes after the cutting. In other words, the plurality of reinforcing members 23 are constituted by two types of members having different shapes. The second reinforcing member 23b corresponds to a fourth member, and the first reinforcing member 23a corresponds to a fifth member. Note that, in the following description, unless otherwise specified, a configuration common to the first reinforcing member 23a and the second reinforcing member 23b will be described.

The first reinforcing member 23a and the second reinforcing member 23b are both bent to form a substantially U-shape when viewed from the +W directions. Specifically, each of the first reinforcing member 23a and the second reinforcing member 23b includes a flat plate-shaped main body portion 30 along the UW plane, a flat plate-shaped first sidewall portion 31 provided on the −U side of the main body portion 30 and along the VW plane, and a flat plate-shaped second sidewall portion 32 provided on the +U side of the main body portion 30 and along the VW plane. The first sidewall portion 31 is formed by bending an end portion of the main body portion 30 on the −U side substantially perpendicularly so as to protrude in the +V direction, and the second sidewall portion 32 is formed by bending an end portion of the main body portion 30 on the +U side substantially perpendicularly so as to protrude in the +V direction. In a state in which the reinforcing member 23 is disposed between the top surface member 21 and the bottom surface member 22, the main body portion 30, the first sidewall portion 31 and the second sidewall portion 32 intersect the top surface member 21 and the bottom surface member 22. Here, “intersecting” means that the directions of the surfaces of the flat plate-shaped members are different from each other. Typically, the main body portion 30, the first sidewall portion 31, and the second sidewall portion 32 are orthogonal to the top surface member 21 and the bottom surface member 22.

On the +W side of the first sidewall portion 31, a flat plate-shaped first bent portion 33 is provided along the UV plane. The first bent portion 33 is formed by bending an end portion of the first sidewall portion 31 on the +W side substantially perpendicularly so as to protrude in the +U direction. Similarly, on the +W side of the second sidewall portion 32, a flat plate-shaped second bent portion 34 is provided along the UV plane. The second bent portion 34 is formed by bending an end portion of the second sidewall portion 32 on the +W side substantially perpendicularly so as to protrude in the −U direction. The second bent portion 34 is formed so as to be positioned on substantially the same virtual plane as that of the first bent portion 33.

On the −W side of the main body portion 30, a flat plate-shaped third bent portion 35 is provided along the UV plane. The third bent portion 35 is formed by bending an end portion of the main body portion 30 on the −W side substantially perpendicularly so as to protrude in the +V direction. Further, on the +W side of the main body portion 30, flat plate-shaped fourth bending portions 36a and 36b are provided along the UV plane.

The fourth bent portions 36a and 36b protrude in different directions in the first reinforcing member 23a and the second reinforcing member 23b, respectively. Specifically, the fourth bent portion 36a of the first reinforcing member 23a is formed by bending the end portion of the main body portion 30 on the +W side substantially perpendicularly so as to protrude in the −V direction. On the other hand, the fourth bent portion 36b of the second reinforcing member 23b is formed by bending the end portion of the main body portion 30 on the +W side substantially perpendicularly so as to protrude in the +V direction. The fourth bent portions 36a and 36b are formed so as to be positioned on substantially the same virtual plane as that of the first bent portion 33 and the second bent portion 34.

Assuming that the +V direction side, on which the first sidewall portion 31 and the second sidewall portion 32 protrude from the main body portion 30, is the front side of the reinforcing member 23, and the −V direction side is the rear side of the reinforcing member 23, in the first reinforcing member 23a, the first sidewall portion 31, the second sidewall portion 32, and the third bent portion 35 are bent frontward, while the fourth bent portion 36a is bent rearward. On the other hand, in the second reinforcing member 23b, all of the first sidewall portion 31, the second sidewall portion 32, the third bent portion 35, and the fourth bent portion 36b are bent frontward. Thus, in the second reinforcing member 23b, a rear surface thereof, which is a surface on the rear side of the main body portion 30, is a flat surface having no protrusion.

The second reinforcing member 23b having no protrusion on the rear surface thereof is disposed along the peripheral edge of the base frame 20, in a posture in which the rear surface of the second reinforcing member 23b faces outward. Since there is no protrusion on the rear surface of the second reinforcing member 23b, the second reinforcing member 23b can be disposed in very close proximity to the peripheral edge of the base frame 20. On the other hand, the first reinforcing member 23a is disposed further to the inner side of the base frame 20 than the second reinforcing member 23b. Since the fourth bent portion 23a on the +W side is bent rearward, the first reinforcing member 36a is less likely to fall rearward than the second reinforcing member 23b, when the first reinforcing member 23a is placed with the +W side thereof facing down.

At substantially the center of the end portion of the main body portion 30 on the +W side, protruding portions 40a and 40b, which are separated from the fourth bent portions 36a and 36b, are formed within a range in which the fourth bent portions 36a and 36b are provided. The protruding portion 40b of the second reinforcing member 23b is formed in the same plane as that of the main body portion 30, and protrudes in the +W direction from the outer surface of the fourth bending portion 36b, that is, the surface of the fourth bending portion 36b on the +W side. On the other hand, the protruding portion 40a of the first reinforcing member 23a is bent such that the tip thereof protrudes in the −V direction, and does not protrude in the +W direction from the outer surface of the fourth bent portion 36a.

In both the first reinforcing member 23a and the second reinforcing member 23b, a first insertion portion 41 protruding in the +W direction is formed at the end portion of the first sidewall portion 31 on the +W side, so that the position of the first insertion portion 41 is aligned with the position at which the first bent portion 33 is provided. The first insertion portion 41 protrudes in the +W direction from the outer surface of the first bent portion 33, that is, the surface thereof on the +W side. An end portion of the first sidewall portion 31 on the −W side is formed so as to be positioned on substantially the same virtual plane as that of the outer surface of the third bent portion 35, that is, the surface thereof on the −W side.

Similarly, in both the first reinforcing member 23a and the second reinforcing member 23b, a second insertion portion 42 protruding in the +W direction is formed at the end portion of the second sidewall portion 32 on the +W side, so that the position of the second insertion portion 42 is aligned with the position at which the second bent portion 34 is provided. The second insertion portion 42 protrudes in the +W direction from the outer surface of the second bent portion 34, that is, the surface thereof on the +W side. Further, an end portion of the second sidewall portion 32 on the −W side is formed so as to be positioned on substantially the same virtual plane as that of the outer surface of the third bent portion 35, that is, the surface thereof on the −W side. The first insertion portion 41 and the second insertion portion 42 each correspond to an insertion portion.

The first insertion portion 41, the second insertion portion 42, and the protruding portion 40b, all of which protrude in the +W direction, are inserted into the top surface member 21. Specifically, the first insertion portion 41 is inserted into a first opening portion 24 formed at the top surface member 21, and the second insertion portion 42 is inserted into a second opening portion 25 formed at the top surface member 21. The first opening portion 24 and the second opening portion 25 each correspond to an opening portion. The protruding portion 40b of the second reinforcing member 23b is inserted into a third opening portion 26 formed at the top surface member 21. Here, the first sidewall portion 31 and the second sidewall portion 32 have substantially symmetrical shapes, but the first insertion portion 41 and the second insertion portion 42 have different lengths in the +V directions. Specifically, the length of the second insertion portion 42 in the +V directions, that is, the length in the direction along the top surface member 21 and the bottom surface member 22 is longer than that of the first insertion portion 41.

Two first contact portions 45 separated from the third bent portion 35 are formed at the end portion of the main body portion 30 on the −W side within a range in which the third bent portion 35 is provided. In other words, the main body portion 30 includes the first contact portions 45. The two first contact portions 45 are disposed to be separated from each other in the +U directions. The first contact portion 45 is formed in the same plane as that of the main body portion 30, and protrudes by a predetermined minute amount in the −W direction from the outer surface of the third bent portion 35, that is, the surface thereof on the −W side. For example, the first contact portion 45 protrudes from the outer surface of the third bent portion 35 in the −W direction by about 0.1 mm. The first contact portion 45 is an end surface of a cut portion cut by a cutting die, and corresponds to a first end surface.

Two second contact portions 46 separated from the fourth bent portions 36a and 36b are formed at the end portion of the main body portion 30 on the +W side within a range in which the fourth bent portions 36a and 36b are provided. In other words, the main body portion 30 includes the second contact portions 46. The two second contact portions 46 are disposed on both sides of the protruding portions 40a and 40b in the +U directions, and the positions thereof in the +U directions are substantially the same as the positions of the first contact portions 45 in the +U directions. The second contact portions 46 are formed in the same plane as that of the main body portion 30, and protrude by a predetermined minute amount in the +W direction from the outer surfaces of the fourth bent portions 36a and 36b, that is, the surfaces thereof on the +W side. For example, the second contact portions 46 protrude in the +W direction from the outer surfaces of the fourth bent portions 36a and 36b by about 0.1 mm. The second contact portion 46 is an end surface of the cut portion cut by the cutting die, and corresponds to a second end surface.

In a state in which the reinforcing member 23 is disposed between the top surface member 21 and the bottom surface member 22, the first contact portions 45 are in contact with an inner surface 22b of the bottom surface member 22, that is, the surface thereof on the +Z side, and the second contact portions 46 are in contact with an inner surface 21b of the top surface member 21, that is, the surface thereof on the −Z side. In other words, the interval between the top surface member 21 and the bottom surface member 22 in the +Z directions is defined by a distance H between the tip of the first contact portion 45 and the tip of the second contact portion 46 of the main body portion 30. The first contact portion 45 and the second contact portion 46 are formed in the same plane as that of the main body portion 30, and the main body portion 30 is not subjected to a bending process between the first contact portion 45 and the second contact portion 46. In other words, since the distance H between the first contact portion 45 and the second contact portion 46 is a distance determined by the cutting die, as long as the same cutting die is used, variations in the distance H are negligibly small. In addition, since a secondary process, such as the bending process, is not performed after the cutting by the cutting die, a desired accuracy can be easily secured for the first contact portion 45 and the second contact portion 46.

In both the first reinforcing member 23a and the second reinforcing member 23b, a third contact portion 47 separated from the first bent portion 33 is formed at the end portion of the first sidewall portion 31 on the +W side within a range in which the first bent portion 33 is provided. The third contact portion 47 protrudes by a predetermined minute amount in the +W direction from the outer surface of the first bent portion 33, that is, the surface thereof on the +W side. In addition, at the end portion of the second sidewall portion 32 on the +W side, a fourth contact portion 48 separated from the second bent portion 34 is formed within a range in which the second bent portion 34 is provided. The fourth contact portion 48 protrudes by a predetermined minute amount in the +W direction from the outer surface of the second bent portion 34, that is, the surface thereof on the +W side. In a state in which the reinforcing member 23 is disposed between the top surface member 21 and the bottom surface member 22, the third contact portion 47 and the fourth contact portion 48 are also in contact with the inner surface 21b of the top surface member 21, that is, the surface thereof on the −Z side. Similarly to the first contact portion 45 and the second contact portion 46, the third contact portion 47 and the fourth contact portion 48 are end surfaces of the cut portion cut by the cutting die. Since the secondary process such as the bending process is not performed after the cutting by the cutting die, the desired accuracy can be easily secured also for the third contact portion 47 and the fourth contact portion 48.

Next, a procedure for assembling the base frame 20 will be described.

First, the top surface member 21 is installed in a vertically inverted posture. In other words, as illustrated in FIG. 8, the top surface member 21 is installed such that an outer surface 21a facing the outer side of the base frame 20 faces downward, and the inner surface 21b facing the inner side of the base frame 20 faces upward. Thereafter, the plurality of reinforcing members 23 are disposed on the top surface member 21.

As described above, at the top surface member 21, the first opening portion 24 and the second opening portion 25, into which the first insertion portion 41 and the second insertion portion 42 are respectively inserted, are formed in advance so as to correspond to the position at which the reinforcing member 23 is to be disposed (see FIG. 6). In addition, at the position at which the second reinforcing member 23b is disposed, the third opening portion 26 into which the protrusion 40b is inserted is formed in advance. On the other hand, the third opening portion 26 corresponding to the protrusion 40b is not formed at the position at which the first reinforcing member 23a is to be disposed. Thus, the second reinforcing member 23a is inhibited from being erroneously disposed at the position at which the first reinforcing member 23b is to be disposed. On the other hand, the first reinforcing member 23a may be disposed at the position at which the second reinforcing member 23b is to be disposed. However, in a case in which the first reinforcing member 23a is erroneously disposed instead of the second reinforcing member 23a that is to be disposed along the peripheral edge of the base frame 20, the fourth bent portion 36a protrudes outward from the peripheral edge, and thus, the erroneous disposition is unlikely to be overlooked.

Further, as described above, the length of the second insertion portion 42 in the ±V directions is longer than that of the first insertion portion 41. Then, the lengths of the first opening portion 24 and the second opening portion 25 formed at the top surface member 21 are set to be the lengths of the corresponding insertion portions. In other words, the second insertion portion 42 having the longer length in the ±V directions cannot be inserted into the first opening portion 24 corresponding to the first insertion portion 41 having the shorter length in the ±V directions. Therefore, when the reinforcing member 23 is disposed to be oriented with the predetermined orientation, the first insertion portion 41 and the second insertion portion 42 can be inserted into the first opening portion 24 and the second opening portion 25, respectively. On the other hand, when the reinforcing member 23 is disposed to be oriented with an orientation different from the predetermined orientation, specifically, when the front-rear direction of the reinforcing member 23 is different from the predetermined direction, the first insertion portion 41 and the second insertion portion 42 cannot be inserted into the first opening portion 24 and the second opening portion 25, respectively. As a result, the reinforcing member 23 is inhibited from being disposed such that the front side and the rear side thereof are oriented with a wrong orientation.

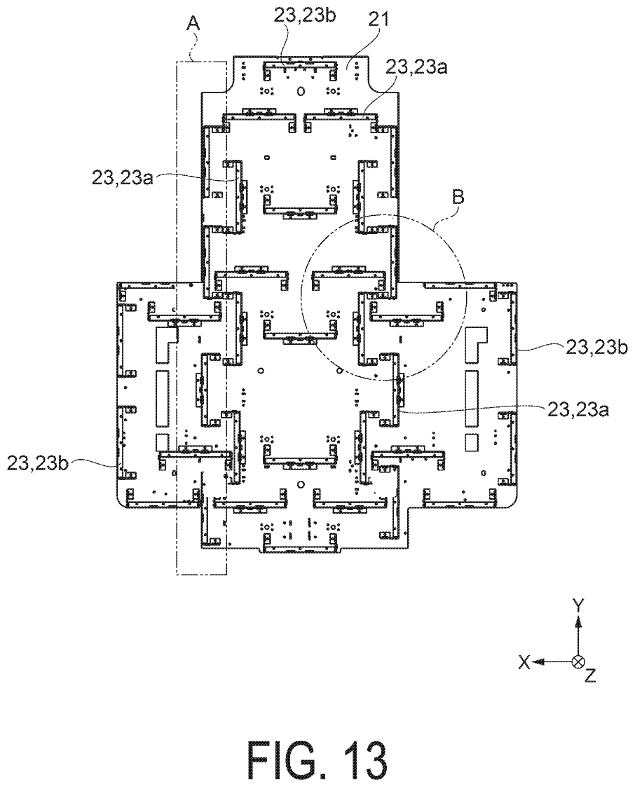

FIG. 13 is a plan view illustrating a state in which the reinforcing members 23 are disposed on the top surface member 21.

As illustrated in FIG. 13, the reinforcing members 23 are disposed in a region that is required to be flat with a relatively high degree of accuracy. Therefore, the plurality of reinforcing members 23 are densely disposed in a region that is required to be flat over a wide area.

Further, in a case in which the region that is required to be flat with the high degree of accuracy extends linearly, as in a portion A surrounded by a two dot chain line in FIG. 13, a plurality of the reinforcing members 23 are disposed in a row at intervals, and others of the reinforcing members 23 are disposed at positions displaced from the row so as to correspond to gaps between the plurality of reinforcing members 23. Specifically, among directions parallel to the top surface member 21 and the bottom surface member 22, when a direction in which the region that is required to be flat with the high degree of accuracy extends is defined as a first direction, the plurality of reinforcing members 23 are disposed in a row along the first direction in a posture in which the main body portion 30 extends along the first direction, while having an interval therebetween that is shorter than the length of the main body portion 30 along the first direction. Then, at the position corresponding to the gap between the reinforcing members 23, the other reinforcing member 23 is disposed so as to be separated from the gap in a second direction intersecting the first direction. The reinforcing member 23 disposed at the position corresponding to the gap is also disposed in the posture in which the main body portion 30 extends along the first direction, and is also disposed so as to overlap both of the two reinforcing members 23 provided on both sides of the gap when viewed from the second direction.

By adopting such an arrangement, even when the reinforcing member 23 having a relatively short length is used, it is possible to obtain highly accurate flatness over a relatively long range. Here, it is preferable that the front-rear direction of the reinforcing members 23 disposed in a row, and the front-rear direction of the reinforcing members 23 disposed at the positions corresponding to the gaps face each other, as illustrated in FIG. 13. In other words, it is preferable that the +V side of the reinforcing members 23 disposed in a row and the +V side of the reinforcing members 23 corresponding to the gaps be disposed to face each other. However, the respective front-rear directions may be directions other than those described above. Note that two of the adjacent reinforcing members 23 among the reinforcing members 23 disposed in a row correspond to a first member and a second member, respectively. Further, the reinforcing member 23 disposed at a position separated from the first member and the second member in the second direction so as to overlap the first member and the second member when viewed from the second direction corresponds to a third member.

In addition, it is preferable that four of the reinforcing members 23 be disposed in a cross shape in a portion in which, of the peripheral edge of the base frame 20, the peripheral edge extending in the +X directions and the peripheral edge extending in the +Y directions intersect each other, as in a portion B surrounded by a two dot chain line in FIG. 13. Here, the orientation of the front-rear direction of each of the reinforcing members 23 is not limited, but, as illustrated in FIG. 13, it is preferable that the reinforcing members 23 be disposed so as to be oriented in a common rotational direction, in other words, disposed so as to be rotationally symmetrical with each other at 90-degree intervals.

After the arrangement of all the reinforcing members 23 on the top surface member 21 is complete, the bottom surface member 22 is disposed on the reinforcing members 23 in a vertically inverted posture. In other words, the bottom surface member 22 is disposed such that an outer surface 22a facing the outer side of the base frame 20 faces upward, and the inner surface 22b facing the inner side of the base frame 20 faces downward.

When the bottom surface member 22 is disposed, if the bottom surface member 22 cannot be appropriately positioned and smoothly disposed, the reinforcing member 23 may fall over. If the reinforcing member 23 falls over on the inner side of the peripheral edge of the base frame 20, it is difficult to recognize that the reinforcing member 23 has fallen over from the outside. Thus, there is a risk that the assembly of the base frame 20 may be continued without noticing that the reinforcing member 23 has fallen over. However, in the present embodiment, since the first reinforcing member 23a, which is unlikely to fall over, is disposed on the inner side of the peripheral edge, the reinforcing member 23 is inhibited from falling over as the result of a small impact. On the other hand, although the second reinforcing member 23b, which is disposed at the peripheral edge of the base frame 20, may fall over due to an impact, since the falling over of the reinforcing member 23 can be easily recognized at the peripheral edge, the assembly of the base frame 20 is not continued without noticing that the reinforcing member 23 has fallen over.

After the bottom surface member 22 is disposed, the bottom surface member 22 and the reinforcing members 23 are joined to each other, and the top surface member 21 and the reinforcing members 23 are joined to each other by welding. The bottom surface member 22 and the reinforcing member 23 are welded to each other on the outer surface 22a side of the bottom surface member 22. Specifically, the third bent portion 35 of the reinforcing member 23 and the bottom surface member 22 are joined by welding. Further, a through hole 27 (see FIG. 7) into which an electrode for welding is inserted is formed at the bottom surface member 22, and the welding between the top surface member 21 and the reinforcing member 23 is performed by the electrode inserted via the through hole 27, from the outside of the bottom surface member 22. Specifically, the first bent portion 33, the second bent portion 34, and the fourth bent portions 36a and 36b of the reinforcing member 23 are joined to the top surface member 21 by welding. In other words, the joining between the bottom surface member 22 and the reinforcing members 23 and the joining between the top surface member 21 and the reinforcing members 23 can be performed without changing the posture of the base frame 20.

When the base frame 20 is completed through the above-described operations, the base frame 20 is installed in an original posture in which the top surface member 21 is positioned above the bottom surface member 22. Thereafter, a plurality of frame members are three-dimensionally assembled on the base frame 20, and each component constituting the recording device 1 is disposed at a predetermined position so as to be supported by the frame members or the base frame 20. In other words, each member including the recording unit 10 is supported by the base frame 20 directly or via the frame member. Finally, exterior members such as the housing 2 and the rear cover 3 are mounted to complete the recording device 1.

As described above, with the base frame 20 and the recording device 1 according to the present embodiment, it is possible to obtain the following effects.

According to the present embodiment, the first contact portion 45, which is the end surface of the flat plate-shaped main body portion 30 in the −W direction, comes into contact with the bottom surface member 22, and the second contact portion 46, which is the end surface of the main body portion 30 in the +W direction, comes into contact with the top surface member 21. In other words, the interval between the top surface member 21 and the bottom surface member 22 is defined by the distance H between the tip of the first contact portion 45 and the tip of the second contact portion 46. Thus, it is possible to define the interval between the top surface member 21 and the bottom surface member 22 with a higher degree of accuracy than an accuracy obtained in a configuration in which the interval is defined by a portion subjected to a bending process. As a result, it is possible to easily realize the base frame 20 that is flat with the high degree of accuracy.

According to the present embodiment, since the plurality of reinforcing members 23 are disposed between the top surface member 21 and the bottom surface member 22, it is possible to realize the base frame 20 that is flat with a high degree of accuracy over a wide area of the top surface member 21 and the bottom surface member 22.

According to the present embodiment, when the region required to be flat with a high degree of accuracy extends linearly along the first direction, the plurality of reinforcing members 23 are disposed in a row at intervals, and the other reinforcing members 23 are disposed at portions corresponding to the gaps between the plurality of reinforcing members 23 at the positions displaced from the row in the second direction. In other words, since a space between the plurality of reinforcing members 23 disposed in a row, that is, a space in which the reinforcing member 23 is absent is reinforced by the other reinforcing member 23 disposed being displaced in the second direction, it is possible to realize the base frame 20 that is flat with a high degree of accuracy over a long range in the first direction, without using a reinforcing member which is extremely long in the first direction.

According to the present embodiment, since the first reinforcing member 23a and the second reinforcing member 23b constituting the plurality of reinforcing members 23 are formed from the plate-shaped materials cut into the same shape, it is not necessary to use a plurality of the cutting dies. As a result, with respect to the interval between the first contact portion 45 and the second contact portion 46, variations in each individual cutting die are reduced, and it is thus possible to realize the base frame 20 that is flat with a high degree of accuracy.

According to the present embodiment, the second reinforcing member 23b disposed along the peripheral edge, and the first reinforcing member 23b disposed on the inner side of the second reinforcing member 23a are subjected to the different bending processes after being cut into the same shape. Specifically, the second reinforcing member 23b is bent into a shape in which outward protrusion is suppressed, and the first reinforcing member 23a is bent into a shape in which the first reinforcing member 23a is unlikely to fall over. As described above, although the first reinforcing member 23a and the second reinforcing member 23b have the different shapes depending on the positions at which they are disposed, the first reinforcing member 23a and the second reinforcing member 23b can be formed using the same cutting die, and it is thus possible to suppress the variations in the distance between the first contact portion 45 and the second contact portion 46.

According to the present embodiment, the first insertion portion 41 and the second insertion portion 42 inserted into the top surface member 21 are formed at the reinforcing member 23, and the first opening portion 24 and the second opening portion 25 into which the first insertion portion 41 and the second insertion portion 42 are inserted are formed at the top surface member 21. Therefore, it is possible to easily position the reinforcing member 23 with respect to the top surface member 21.

According to the present embodiment, since the first insertion portion 41 and the second insertion portion 42 can be inserted into the first opening portion 24 and the second opening portion 25, respectively, only when the reinforcing member 23 is disposed to be oriented with the predetermined orientation, it is possible to inhibit the reinforcing member 23 from being disposed to be oriented with the wrong orientation.

According to the present embodiment, the reinforcing member 23 includes the first insertion portion 41, and the second insertion portion 42 whose length in the +V directions is longer than that of the first insertion portion 41, and the first opening portion 24 into which the first insertion portion 41 is inserted, and the second opening portion 25 into which the second insertion portion 42 is inserted are formed at the top surface member 21. In addition, the second insertion portion 42 cannot be inserted into the first opening portion 24. In other words, since the first insertion portion 41 and the second insertion portion 42 can be inserted into the first opening portion 24 and the second opening portion 25, respectively, only when the reinforcing member 23 is disposed being oriented in the predetermined direction, it is possible to inhibit the reinforcing member 23 from being disposed to be oriented with the wrong orientation.

According to the present embodiment, the through hole 27 into which the welding electrode is inserted is formed at the bottom surface member 22, and the top surface member 21 and the reinforcing member 23 can be joined to each other through the through hole 27. Thus, the joining between the top surface member 21 and the reinforcing member 23 and the joining between the bottom surface member 22 and the reinforcing member 23 can be performed in the same posture, and the operational efficiency is thus improved.

The embodiment described above may be modified as follows.

In the embodiment described above, the bottom surface member 22 is disposed after the plurality of reinforcing members 23 are disposed on the top surface member 21. However, the top surface member 21 may be disposed after the plurality of reinforcing members 23 are disposed on the bottom surface member 22. In this case, the first opening portion 24, the second opening portion 25, and the third opening portion 26 into which the first insertion portion 41, the second insertion portion 42, and the protruding portion 40b are respectively inserted are formed at the bottom surface member 22, and the through hole 27 into which the electrode for welding is inserted is formed at the top surface member 21.

In the embodiment described above, the number of insertion portions included in one of the reinforcing members 23 and the number of opening portions into which the insertion portions are inserted are not limited to two, and may be three or more. Further, in addition to the first insertion portion 41 and the second insertion portion 42 that are inserted into the top surface member 21, an insertion portion that is inserted into the bottom surface member 22 may be formed at the reinforcing member 23. In this case, an opening portion corresponding to this insertion portion is formed at the bottom surface member 22.

In the embodiment described above, the lengths of the first insertion portion 41 and the second insertion portion 42 of the reinforcing member 23 in the +V directions are different from each other in order to inhibit the reinforcing member 23 from being disposed on the top surface member 21 such that the front side and the rear side thereof are oriented with the wrong orientation. In addition, the lengths of the first opening portion 24 and the second opening portion 25 formed at the top surface member 21 are set to be the lengths corresponding to the lengths of the corresponding insertion portions. However, the configuration for inhibiting the reinforcing member 23 from being disposed such that the front-rear direction thereof are oriented with the wrong orientation is not limited to the above-described configuration, and may be any configuration as long as the plurality of insertion portions cannot be inserted into the plurality of openings when the reinforcing member 23 is disposed with the wrong orientation. For example, a configuration may be adopted in which three or more insertion portions are asymmetrically disposed in the reinforcing member 23, and opening portions corresponding to the insertion portions are formed at the top surface member 21. In this case, the length of each of the insertion portions may be the same length.

Although the base frame 20 has been described in the embodiment described above, the present disclosure may be applied to other frames.

In the embodiment described above, the liquid discharged by the recording unit 10 is not limited to the ink. For example, the recording unit 10 may discharge a liquid body containing a material, such as an electrode material or a color material used to manufacture various types of displays, in a dispersed state or a dissolved state.

In the embodiment described above, the recording device 1 is a device that performs printing on the medium, and may be a serial printer, a lateral printer, a line printer, a page printer, or the like. Further, a recording method is not limited to the inkjet method, and may be a thermal method, a dot-impact method, a laser method, or the like.

What is claimed is:

1. A recording device frame comprising:
a top surface member formed from a plate-shaped material;
a bottom surface member formed from a plate-shaped material and disposed in parallel to the top surface member; and
a reinforcing member disposed between the top surface member and the bottom surface member, wherein
the reinforcing member is formed from a plate-shaped material and includes a main body portion having a flat plate shape and intersecting the top surface member and the bottom surface member, and
the main body portion includes a first end surface in contact with the bottom surface member, and a second end surface in contact with the top surface member.

2. The recording device frame according to claim 1, wherein
a plurality of the reinforcing members are disposed between the top surface member and the bottom surface member.

3. The recording device frame according to claim 2, wherein
the plurality of reinforcing members include a first member, a second member, and a third member, including the main body portion disposed in a posture along a first direction parallel to the top surface member and the bottom surface member,
the first member and the second member are disposed in a row along the first direction at an interval shorter than a length of the main body portion along the first direction, and
the third member is disposed at a position separated from the first member and the second member in a second direction intersecting the first direction, and overlaps the first member and the second member when viewed from the second direction.

4. The recording device frame according to claim 2, wherein
the plurality of reinforcing members are formed from plate-shaped materials cut into a same shape.

5. The recording device frame according to claim 4, wherein
the plurality of reinforcing members include a fourth member disposed along a peripheral edge of the recording device frame, and a fifth member disposed further to an inner side of the recording device frame than the fourth member, and
the fourth member and the fifth member are subjected to different bending processes.

6. The recording device frame according to claim 1, wherein
the reinforcing member is formed with an insertion portion configured to be inserted into one of the top surface member and the bottom surface member, and
the one of the top surface member and the bottom surface member is formed with an opening portion into which the insertion portion is inserted.

7. The recording device frame according to claim 6, wherein
the reinforcing member includes a plurality of the insertion portions,
the one of the top surface member and the bottom surface member is formed with a plurality of the opening portions into which the plurality of insertion portions are respectively inserted when the reinforcing member is disposed in a predetermined orientation, and
the plurality of insertion portions are configured not to be inserted into the plurality of opening portions when the reinforcing member is disposed in an orientation different from the predetermined orientation.

8. The recording device frame according to claim 7, wherein
the reinforcing member includes, as the plurality of insertion portions, a first insertion portion, and a second insertion portion having a length, in a direction along the top surface member and the bottom surface member, longer than the first insertion portion,
the one of the top surface member and the bottom surface member is formed with a first opening into which the first insertion portion is inserted, and a second opening into which the second insertion portion is inserted as the plurality of opening portions, and
the second insertion portion is configured not to be inserted into the first opening portion.

9. The recording device frame according to claim 1, wherein
one of the top surface member and the bottom surface member is formed with a through hole used to join the other of the top surface member and the bottom surface member to the reinforcing member.

10. A recording device comprising:
a frame; and
a recording unit supported by the frame and configured to perform recording on a medium, wherein
the frame includes
a top surface member formed from a plate-shaped material,
a bottom surface member formed from a plate-shaped material and disposed in parallel to the top surface member, and
a reinforcing member disposed between the top surface member and the bottom surface member,
the reinforcing member is formed from a plate-shaped material and includes a main body portion having a flat plate shape and intersecting the top surface member and the bottom surface member, and
the main body portion includes a first end surface in contact with the bottom surface member, and a second end surface in contact with the top surface member.
